(19) United States
(12) Patent Application Publication
(10) Pub. No.: US 2020/0096130 A1
(43) Pub. Date: Mar. 26, 2020

(54) LINEAR ACTUATORS FOR PRESSURE-REGULATING VALVES

(71) Applicant: Rostra Precision Controls, Inc., Laurinburg, NC (US)

(72) Inventors: Hamid Najmolhoda, Grand Rapids, MI (US); Brian Klynt Baker, Spring Lake, MI (US)

(73) Assignee: Rostra Precision Controls, Inc., Laurinburg, NC (US)

(21) Appl. No.: 16/573,051

(22) Filed: Sep. 17, 2019

Related U.S. Application Data
(60) Provisional application No. 62/735,224, filed on Sep. 24, 2018.

(51) Int. Cl. F16K 31/06; H01F 7/16; H01F 7/08; H01F 27/28

(52) U.S. Cl. CPC F16K 31/0675; H01F 7/16; H01F 2007/086; H01F 27/2823; H01F 7/081

(57) ABSTRACT

A linear actuator configured to axially move a plunger. The linear actuator includes a flux sleeve surrounded by a bobbin housing a wire coil. The flux sleeve defines an armature cavity extending along a movement axis, where a magnetic field is created within the flux sleeve when a current is applied to the wire coil. An armature is receivable within the armature cavity, where the magnetic field created within the flux sleeve acts upon the armature such that the armature moves along the movement axis based on the magnetic field, and where moving the armature moves the plunger. A liner is positioned within the armature cavity between the armature and the flux sleeve. The liner includes at least one of a polyamide and a polyimide.

### CROSS REFERENCE TO RELATED APPLICATIONS

This application claims the benefit of U.S. Provisional Patent Application No. 62/735,224, filed Sep. 24, 2018, which is incorporated herein by reference in its entirety.

### FIELD

The present disclosure generally relates to linear actuators, and more particularly to improving the performance of linear actuators within pressure-regulating valves.

### BACKGROUND

The Background and Summary are provided to introduce a foundation and selection of concepts that are further described below in the Detailed Description. The Background and Summary are not intended to identify key or essential features of the potentially claimed subject matter, nor are they intended to be used as an aid in limiting the scope of the potentially claimed subject matter.

U.S. Pat. No. 8,854,164, which is incorporated by reference herein, discloses an exemplary linear actuator for a pressure-regulating valve. The disclosure provides that modern passenger-car automatic transmissions commonly use hydraulically actuated clutches for changing gears. To allow shifting operations to proceed smoothly and imperceptibly for the driver, the hydraulic pressure within these clutches must be controlled with the highest pressure precision, based on predefined pressure ramps. Electromagnetically controlled linear actuators are used for adjusting the pressure ramps mentioned within these pressure-regulating valves.

Pressure-regulating valves are generally of a seat or valve-piston type of construction. The required pressure level is provided by achieving equilibrium between a hydraulic force on the valve seat, and a force of an electromagnet as a function of current. To provide precise control over these pressures, a current coil creating the magnetic force is controlled corresponding to an exact, predetermined characteristic curve.

Modern electromagnets commonly include a pole tube, which combines the radial in-feed of the magnetic flux into the armature (the magnet core), and the complementary magnetic pole for the magnet armature (the pole body), in one device. To prevent a magnetic short-circuit within the pole tube, a V-shaped groove is often introduced. In particular, this reduction of magnetic iron cross-section provides a state of saturation in response to low coil currents, thereby acting as an air gap. These air gaps improve the magnetic efficiency, consequently providing higher magnetic forces.

However, a known disadvantage in this modern design is that high magnetic transverse forces develop, increasing friction and hysteresis, and also decreasing the precision and accuracy of pressure. In address this issue, coatings are often applied to reduce friction, and to provide a magnetic separation between armature and pole tube. Generally, these coatings are costly to produce because they require the handling of individual parts during the coating process. In certain cases, additional coating processing is required to ensure acceptable geometric accuracy. Moreover, the coatings presently used in the art do not achieve the optimal coefficient of friction achieved by such materials as Teflon.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment according to the present disclosure generally relates to a linear actuator configured to axially move a plunger. The linear actuator includes a flux sleeve surrounded by a bobbin housing a wire coil. The flux sleeve defines an armature cavity extending along a movement axis, where a magnetic field is created within the flux sleeve when a current is applied to the wire coil. An armature is receivable within the armature cavity, where the magnetic field created within the flux sleeve acts upon the armature such that the armature moves along the movement axis based on the magnetic field, and where moving the armature moves the plunger. A liner is positioned within the armature cavity between the armature and the flux sleeve. The liner includes at least one of a polyamide and a polyimide.

Another embodiment generally relates to a linear actuator configured to axially move a plunger. The linear actuator includes a flux sleeve surrounded by a bobbin housing a wire coil. The flux sleeve defines an armature cavity extending along a movement axis therein. A magnetic field is created within the flux sleeve when a current is applied to the wire coil. An armature is receivable within the armature cavity, where the armature has an outer surface that faces the armature cavity, and where a liner recess is defined within the outer surface. A liner is positioned within the liner recess in the outer surface of the armature such that the liner is between the armature and the flux sleeve. The magnetic field created within the flux sleeve acts upon the armature such that the armature moves along the movement axis based on the magnetic field. Moving the armature moves the plunger.

Another embodiment generally relates to a linear actuator configured to axially move a plunger. The linear actuator includes a flux sleeve surrounded by a bobbin housing a wire coil. The flux sleeve defines an armature cavity extending along a movement axis therein. A magnetic field is created within the flux sleeve when a current is applied to the wire coil. An armature is receivable within the armature cavity. The magnetic field created within the flux sleeve acts upon the armature such that the armature moves along the movement axis based on the magnetic field. Moving the armature moves the plunger. A liner positioned within the armature cavity between the armature and the flux sleeve, where the liner moves in conjunction with the armature along the movement axis.

Various other features, objects and advantages of the disclosure will be made apparent from the following description taken together with the drawings.

### BRIEF DESCRIPTION OF THE DRAWINGS

The drawings illustrate embodiments for carrying out the disclosure. The same numbers are used throughout the drawings to reference like features and like components. In the drawings:

FIG. 1 is a cutaway isometric view of a linear actuator as known in the art;

FIG. 2 is a sectional side view depicting a portion of a linear actuator as known in the art;

FIGS. 3-4 are photographs showing isometric views of part of a linear actuator assembly as known in the art;

FIG. 5 is a cutaway isometric view of a linear actuator according to the present disclosure;

FIG. 6 is a photograph showing a side view of portions of the linear actuator shown in FIG. 5; and

FIG. 7 is a photograph showing an isometric view of another embodiment of liner for a linear actuator according to the present disclosure.

### DETAILED DISCLOSURE

This written description uses examples to disclose embodiments of the present disclosure and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present disclosure generally relates to improvements to linear actuators, including those incorporated within pressure-regulating valves. These linear actuated pressure-regulating valves are commonly incorporated within automatic transmissions for automobiles, particularly those having six speeds and more, for example. It is common to have up to eight linear actuator (or solenoid) pressure-regulating valves within a single automotive transmission.

An exemplary linear actuator with a pressure-regulating valve is described in U.S. Pat. No. 8,854,164, which is incorporated by reference herein. The pressure-regulating valve is described therein as providing precise pressure regulation for an automotive transmission by changing the current within a magnetic coil. This results in a corresponding change in the position of an armature within the linear actuator according to the change in electromagnetic forces.

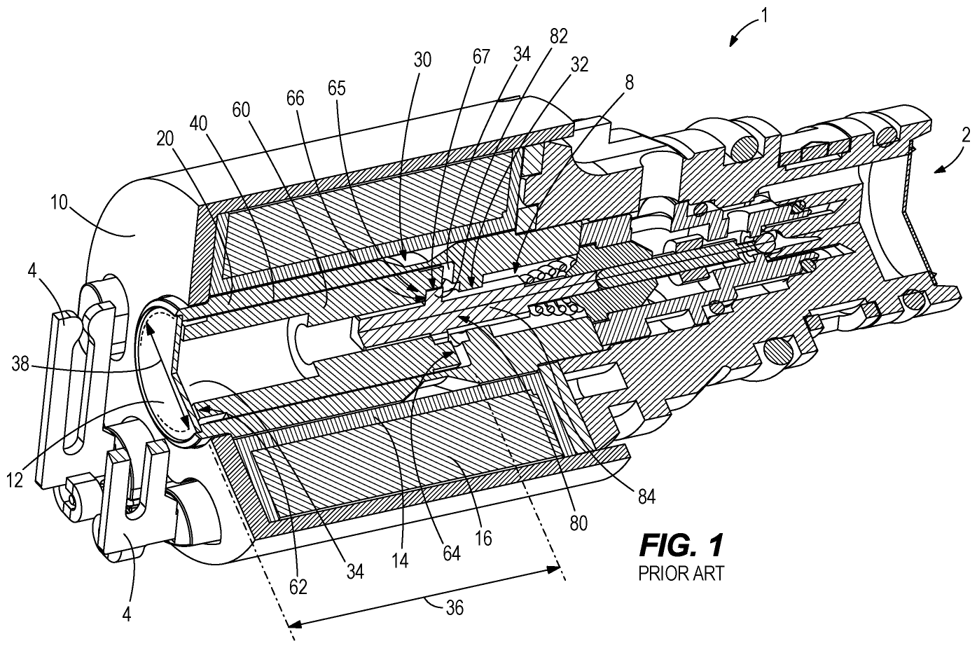

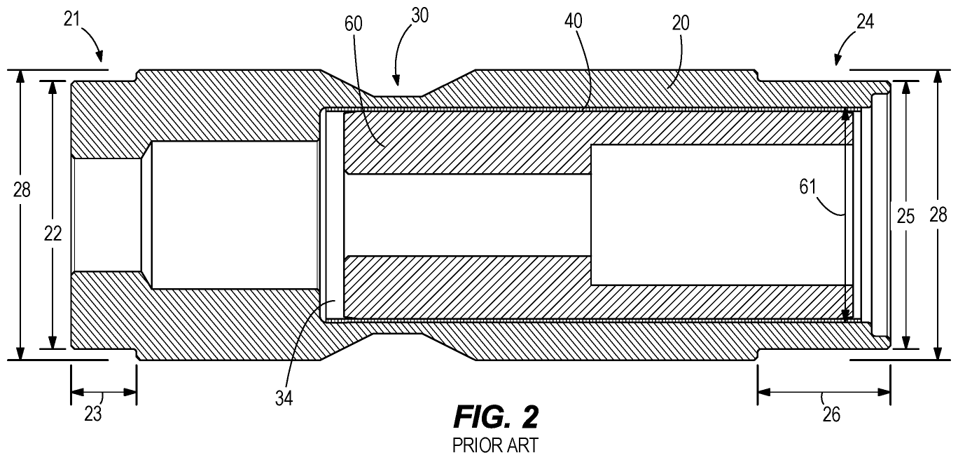

FIGS. 1 and 2 disclose exemplary embodiments of linear actuator 1 as are presently known in the art. The linear actuator 1 comprises a can 10 that houses a flux sleeve 20 that extends between a first end 21 and a second end 24. The flux sleeve 20 generally has a primary diameter 28, but in the embodiment shown also has a first end diameter 22 over a first end length 23 at the first end 21 and a second diameter 25 over a second end length 26 at the second end 24. The flux sleeve 20 further defines a groove 30 for influencing the magnetic flux, as described in U.S. Pat. No. 8,854,164. The flux sleeve 20 is surrounded by a bobbin 14 housing a wire coil 16, which is electrically coupled to an electrical connection 4 in the customary manner.

The flux sleeve 20 further defines an armature cavity 34 having a cavity length 36 and cavity diameter 38 for receiving an armature 60 therein. The armature 60 extends between a first end 62 and second end 64 and has a primary diameter 61 configured to be received within the armature cavity 34 in the flux sleeve 20. As such, changes in the current applied to the wire coil 16 create a change in the magnetic field within the flux sleeve 20, correspondingly moving the armature 60 in a linear manner within the armature cavity 34 in the manner known in the art.

In the exemplary embodiment shown, the armature 60 receives a plunger 8 within a second end shelf 65 defined at the second end 64 of the armature 60. In particular, the second end shelf 65 has a bottom 66 and sidewalls 67 that engage with a lip 82 on the plunger 8. The plunger 8 further has a push rod 84, which actuates the pressure-regulating valve (connectable at a hydraulic port 2) in the manner known in the art.

As stated above, mechanical friction within the linear actuator 1 causes hysteresis in the movement of the armature 60 responsive to the electromagnetic field created by the wire coil 16. This leads to inexactness in the position of the armature 60 (and any plunger 8 or other structures coupled thereto) for actuating the pressure-regulating valve, thus creating inexactness of the pressure-regulating of the valve. For this reason, friction-reducing coatings or liners 40 are sometimes provided between the armature 60 and the flux sleeve 20. This reduces the coefficient of friction between the armature 60 and the flux sleeve 20, thereby decreasing hysteresis and improving the accuracy of the linear actuator 1 in use.

The pressure-regulating valve disclosed in U.S. Pat. No. 8,854,164 includes a film as the liner 40, specifically a glass-fiber fabric incorporating friction-reducing PTFE or Teflon materials therein. This combination provides some reduction in the coefficient of friction, improving performance as discussed. The thickness of the glass-fiber fabric as the liner 40 ranges between 20 and 200 micrometers.

The present inventors have identified issues with the use of coatings or liners 40 as presently known. Coatings are expensive and require substantial processing, increasing the time and expense for each valve. Moreover, present liners 40 are thick, difficult to produce accurately, and also raise costs considerably.

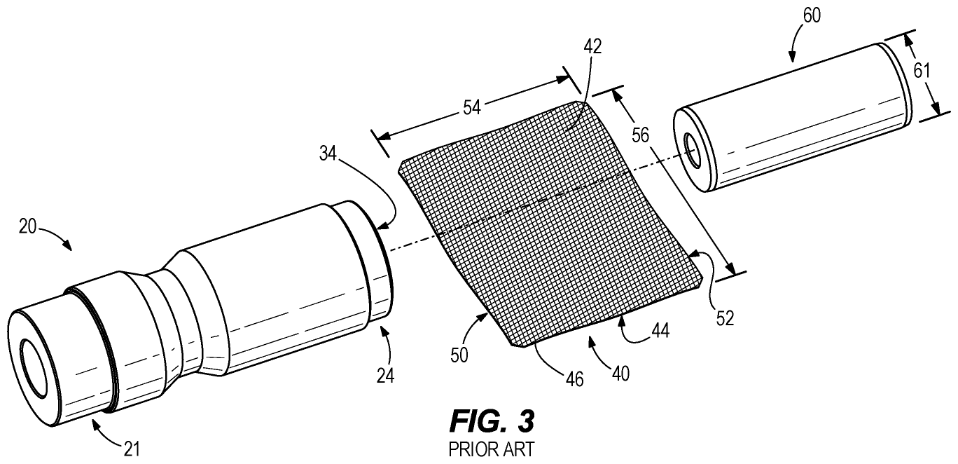

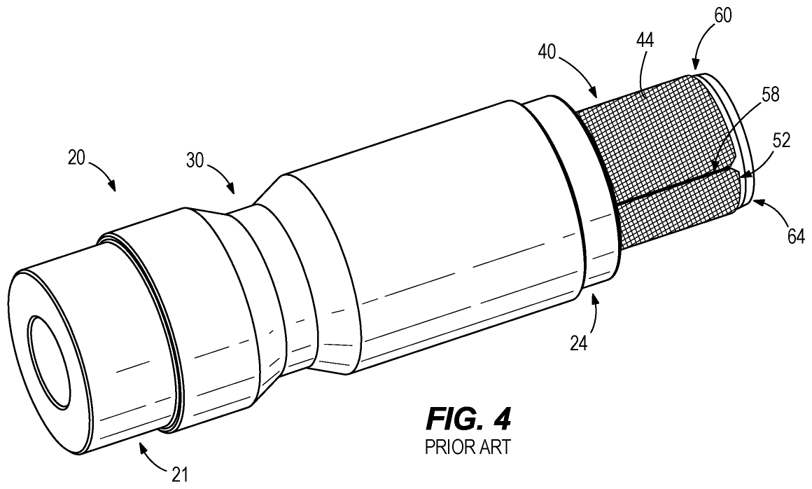

FIGS. 3 and 4 depict an exemplary embodiment of portions of a linear actuator 1 according to the disclosure of U.S. Pat. No. 8,854,164. As shown, the armature 60 is wrapped with a liner 40 prior to inserting the armature 60 within the flux sleeve 20. Exemplary materials for prior art liners 40 include brass, 300 series stainless steel, bearing grade bronze, or teflon coated injection molded surfaces. The liner 40 has a first end 50 and second end 52, defining an axial length 54 therebetween. The liner 40 further has a circumferential length 56 that approximately corresponds to the circumference of the armature 60 such that a butt joint 58 is formed when the armature 60 is wrapped with the liner 40. The liner 40 further comprises an inner surface 42 and an outer surface 44, which define a thickness 46 therebetween. Accordingly, the difference (or gap) between the primary diameter 61 of the armature 60 and the cavity diameter 38 (FIG. 1) of the armature cavity 34 defined within the flux sleeve 20 must accommodate this thickness 46 of the liner 40 therein. Based on the materials presently known to be used in the art, the thicknesses 46 of these liners 40 range between 20 and 200 micrometers, as discussed above.

Through experimentation and development, the present inventors have identified improved methods and materials for making linear actuators 1. Specifically, the presently disclosed linear actuators 1 provide an increase in performance and reduced required dimensions, while also providing a low coefficient of friction between the flux sleeve 20 and the armature 60. In a first embodiment that looks substantially similar to that shown in FIGS. 3-4, the present inventors developed a linear actuator 1 incorporating a polyamide or polyimide film to be positioned as the liner 40 between the flux sleeve 20 and the armature 60. The present inventors have identified that in certain embodiments, the use of a polyamide or polyimide as the liner 40, which has not previously been known in the art, can provide the necessary reduction in the coefficient of friction, while also offering a nominal thickness range between 7 and 15 micrometers. This consequently allows the overall size of the linear actuator 1 to be reduced in a corresponding manner, starting with a reduced cavity diameter 38 in the flux sleeve 20. By reducing the overall size of each linear actuator 1, particularly where eight or more linear actuators 1 are incorporated within a single automatic transmission, to the size of the overall automotive transmission itself can be reduced, providing further gains within the industry. This reduction in size further corresponds to a reduction in cost, as fewer materials are required to produce a flux sleeve 20 having a smaller armature cavity 34 to accommodate the liner 40 and armature 60 and thus, primary diameter 28 overall.

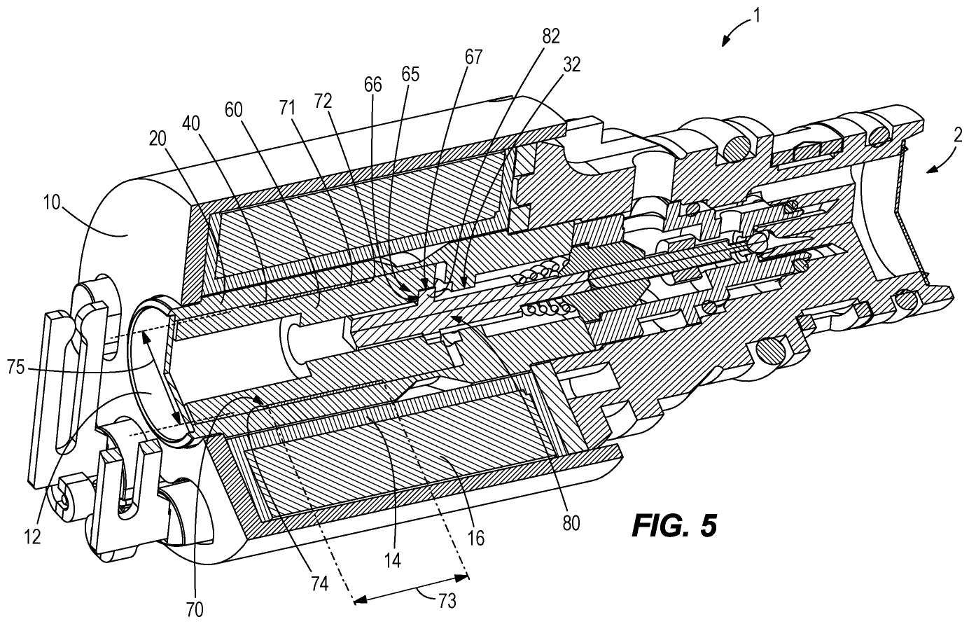

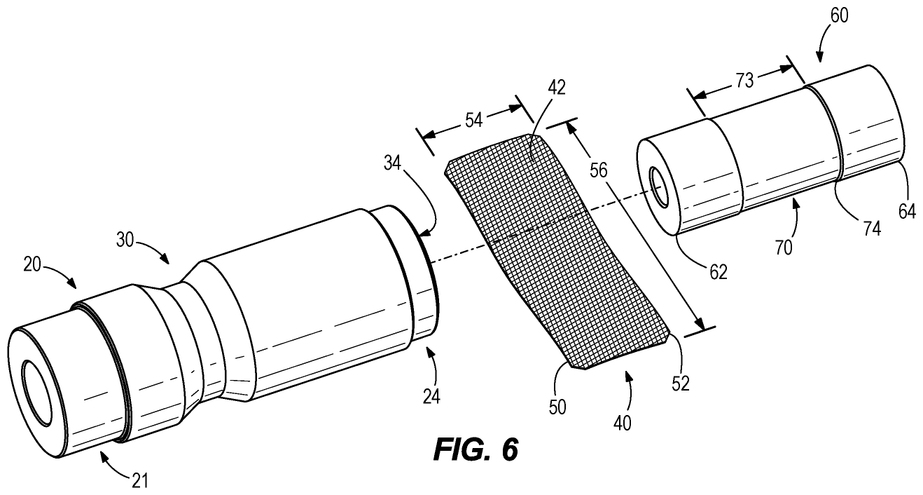

FIGS. 5 and 6 depict a second embodiment according to the present disclosure. In addition to polyamide or polyimide films as discussed above, further materials for the liner 40 include PTFE (Polytetrafluoroethylene) or silicone based materials, for example. The second embodiment enables the reduced size of the linear actuator 1 previously described, including the reduced gap between the cavity diameter 38 of the armature cavity 34 and the primary diameter 61 of the armature 60. However, it further permits the use of a liner 40 having a larger thickness 46, such as liners 40 presently known in the art, within this smaller space. In particular, the armature 60 of the present disclosure has been configured to define a liner recess 70, which comprises a bottom 71 and side walls 72. The liner recess 70 has an axial length 73 and a depth 74 such that the linear recess diameter 75 is defined that is less than the primary diameter 61 of the armature 60.

In this manner, a liner 40 is receivable within the liner recess 70 of the armature 60 such that at least a portion of the thickness 46 of the liner 40 is within the liner recess 70. Accordingly, it will be recognized that the difference between the cavity diameter 38 of the flux sleeve 20 and the primary diameter 61 of the armature 60 need not be greater than or equal to the thickness 46 of the liner 40, as is required of linear actuators 1 known in the art. This permits the use of a liner 40 exceeding the thickness of 200 micrometers (for example) as described in U.S. Pat. No. 8,854,164, without increasing the size of the gap between the flux sleeve 20 and the armature 60. Therefore, the thickness 46 of the liner 40 for the linear actuator 1 of FIGS. 5-6 may be increased without having a detrimental effect on the viability or efficiency of the fit between the armature 60 and the flux sleeve 20.

It should be recognized that in addition to maintaining (or even reducing) the size of the cavity diameter 38 relative to the armature 60, the presently disclosed linear actuator 1 accommodating liners 40 of a greater thickness 46 opens up the possibility of using materials that do not otherwise lend themselves to having a thickness 46 of less than 200 micrometers. In other words, materials that could not previously be used as liners 40 may now be used according to the present disclosure. This may save cost in materials and/or processing, or expand the options of materials for further improvements in durability and reduced friction.

In contrast to designs presently known in the art, the presently disclosed embodiment further provides for a fully dynamic liner 40 that moves with the armature 60 by virtue of the side walls 72 of the liner recess 70. This ensures consistent alignment between the armature 60 and the liner 40 further improving upon the durability of the linear actuator 1 over time and in heavy use.

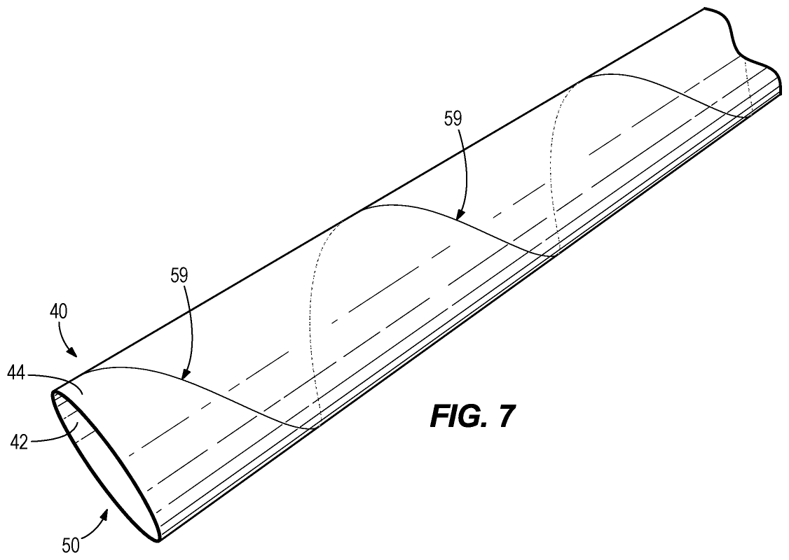

FIG. 7 discloses a yet another embodiment of a liner 40 for use in a linear actuator 1 according to the present disclosure. In the embodiment shown, the liner 40 is formed of a spiral wound tube having an inner surface 42 and outer surface 44 and extending from a first end 50 to a second end 52 (see e.g., FIG. 5). In the present embodiment, the liner 40 is held in the form of a tube by spiral joints 59. This embodiment simplifies the assembly process by not requiring the liner 40 to be wrapped around the armature 60 prior to insertion in the flux sleeve 20 (see FIG. 4). In certain embodiments, the liner 40 may also be split to create the butt joint 58 shown in FIG. 4 to provide further conformance with the armature cavity 34 of the flex sleeve 20 (see FIG. 6). The present inventors have identified it to be particularly advantageous to incorporate FEP (Fluorinated Ethylene Propylene) polyimide within the liner 40. In certain embodiments, FEP is provided as a coating to one or both of the inner surface 42 and outer surface 44 of the liner 40.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

What is claimed is:

1. A linear actuator configured to axially move a plunger, the linear actuator comprising:
a flux sleeve surrounded by a bobbin housing a wire coil, wherein the flux sleeve defines an armature cavity extending along a movement axis therein, and wherein a magnetic field is created within the flux sleeve when a current is applied to the wire coil;
an armature receivable within the armature cavity, wherein the magnetic field created within the flux sleeve acts upon the armature such that the armature moves along the movement axis based on the magnetic field, and wherein moving the armature moves the plunger; and
a liner positioned within the armature cavity between the armature and the flux sleeve, wherein the liner comprises at least one of a polyamide and a polyimide.

2. The linear actuator according to claim 1, wherein the liner has a thickness that is perpendicular to a direction of the armature movement within the armature cavity, and wherein the thickness is less than 20 micrometers.

3. The linear actuator according to claim 1, wherein the liner has a rectangular shape and is configured to be wrapped around the armature when positioned within with the armature cavity.

4. The linear actuator according to claim 3, wherein the liner when wrapped around the armature forms a non-overlapping butt joint.

5. The linear actuator according to claim 1, wherein the liner is a cylinder having an internal diameter corresponding to an outer diameter of the armature.

6. The linear actuator according to claim 1, wherein the armature has an outer surface that faces the armature cavity, wherein a liner recess is defined within the outer surface and configured to receive a portion of the liner therein.

7. The linear actuator according to claim 6, wherein the liner recess prevents relative movement of the liner thereto parallel to the movement axis.

8. The linear actuator according to claim 1, wherein the liner has a thickness that is perpendicular to a direction of the armature movement within the armature cavity, wherein the armature and the armature cavity each have a diameter, and wherein the thickness of the liner is greater than a difference between the diameter of the armature cavity and the diameter of the armature.

9. The linear actuator according to claim 1, wherein the plunger is configured to actuate a pressure regulation valve by controlling the magnetic field created within the flux sleeve.

10. A linear actuator configured to axially move a plunger, the linear actuator comprising:
a flux sleeve surrounded by a bobbin housing a wire coil, wherein the flux sleeve defines an armature cavity extending along a movement axis therein, and wherein a magnetic field is created within the flux sleeve when a current is applied to the wire coil;
an armature receivable within the armature cavity, wherein the armature has an outer surface that faces the armature cavity and wherein a liner recess is defined within the outer surface; and
a liner positioned within the liner recess in the outer surface of the armature such that the liner is between the armature and the flux sleeve;
wherein the magnetic field created within the flux sleeve acts upon the armature such that the armature moves along the movement axis based on the magnetic field, and wherein moving the armature moves the plunger.

11. The linear actuator according to claim 10, wherein the liner provides a relatively reduced coefficient of friction for moving the armature within the flux sleeve.

12. The linear actuator according to claim 10, wherein the liner has a rectangular shape and is configured to be wrapped around the armature when positioned within with the armature cavity.

13. The linear actuator according to claim 12, wherein the liner when wrapped around the armature forms a non-overlapping butt joint.

14. The linear actuator according to claim 10, wherein the liner recess prevents relative movement of the liner thereto parallel to the movement axis.

15. The linear actuator according to claim 10, wherein the armature and the armature cavity each have a diameter, and wherein the difference between the diameter of the armature cavity and the diameter of the armature is less than 20 micrometers.

16. The linear actuator according to claim 15, wherein the thickness is greater than 200 micrometers.

17. The linear actuator according to claim 10, wherein the liner comprises at least one of a polytetrafluoroethylene and a silicone-based material.

18. A linear actuator configured to axially move a plunger, the linear actuator comprising:
a flux sleeve surrounded by a bobbin housing a wire coil, wherein the flux sleeve defines an armature cavity extending along a movement axis therein, and wherein a magnetic field is created within the flux sleeve when a current is applied to the wire coil;
an armature receivable within the armature cavity, wherein the magnetic field created within the flux sleeve acts upon the armature such that the armature moves along the movement axis based on the magnetic field, and wherein moving the armature moves the plunger; and
a liner positioned within the armature cavity between the armature and the flux sleeve, wherein the liner moves in conjunction with the armature along the movement axis.

19. The linear actuator according to claim 18, wherein the liner comprises at least one of a polyamide, a polyimide, a polytetrafluoroethylene, and a silicone-based material.

20. The linear actuator according to claim 18, wherein the armature and the armature cavity each have a diameter, and wherein the difference between the diameter of the armature cavity and the diameter of the armature is less than 20 micrometers.
